(19) United States
(12) Patent Application Publication
(10) Pub. No.: US 2004/0179610 A1
(43) Pub. Date: Sep. 16, 2004

(54) Apparatus and method employing a configurable reference and loop filter for efficient video coding

(76) Inventors: Jiuhuai Lu, Palos Verdes Peninsula, CA (US); Yoshiichiro Kashiwagi, Arcadia, CA (US); Masayuki Kozuka, Arcadia, CA (US)

Correspondence Address: Snell & Wilmer L.L.P., Suite 1200, 1920 Main Street, Irvine, CA, 92614-7230, US

(21) Appl. No.: 10/724,317

(22) Filed: Nov. 26, 2003

Related U.S. Application Data
(60) Provisional application No. 60/449,209, filed on Feb. 21, 2003.

(51) Int. Cl. H04B 1/66; H04N 7/12; H04N 11/02; H04N 11/04

(52) U.S. Cl. 375/240.25; 375/240.29; 375/240.02

(57) ABSTRACT

A video decoding system including a demultiplexer unit, a decoding unit, a loop filter unit, an output switch unit, and a prediction unit. The demultiplexer unit receives encoded video data structures including an encoded video data, a motion data, and an intra-prediction mode data. The decoder unit receives the sum of the encoded video data and an encoded prediction data and outputs a decoded video data. The loop filter receives the decoded video data and outputs a filtered video data based on one or more predetermined filter modes. The output switch unit receives a first control data to selectively output either the decoded video data or the filtered video data that has been encoded to be efficiently decoded based on a particular filtering mode. The prediction unit receives the filtered decoded video data, the motion data, and the intra-prediction mode data along with a second control data in order to output a prediction data for modifying the decoding of other encoded video data.

### CROSS-REFERENCE TO RELATED APPLICATIONS

This application claims the benefit of a provisional application Serial No. 60/449,209 filed on Feb. 21, 2003 for a video decoder architecture employing loop filter for high-definition video coding efficient improvement. The entire contents of the provisional application is incorporated herein by reference.

### FIELD OF THE INVENTION

The present invention relates to a video encoding and decoding, and more particularly pertains to a video decoding system and method for utilizing a configurable filter to decode efficiently encoded high-definition video relative to the available bandwidth.

### DESCRIPTION OF RELATED ART

The ability to capture, store, convey, and present digital images while maintaining texture details in an economical manner has remained a goal of the video industry, and various video compression schemes to minimize the storage space or transmission bandwidth requirements have been proposed and approved.

Many video compression schemes that are widely used in the video industry, such as the MPEG and H.26x series of compression standards from ISO and ITU, employ motion prediction based coding methods using inter-picture prediction. Motion prediction includes determining a block of pixels from a previously encoded picture that closely resembles or matches the current pixel block to be encoded and using that block of previously encoded pixels as a reference block.

If a match is found, motion prediction provides that only the pixel differences between the reference block and the current block will be encoded. Advantageously, the information already included in the reference block does not need to be encoded again in the current block, thereby removing redundancy between the reference block and the current block and reducing or compressing the subsequently encoded picture data. These compression techniques are related to what is commonly known as lossy compression.

Information redundancy reduction is a fundamental technique used to accomplish video picture compression. The effectiveness of information redundancy reduction depends on the similarity of the previously encoded reference block to the current block that is to be encoded. The more differences there are between the reference block and the current block to be encoded indicates that more bits will be required to encode the current block. Part of the existing strategy of motion estimation is to find a reference block that is as similar to the current block as possible in order to yield the minimal difference block to be encoded.

High-definition (HD) video pictures can originate from film and high resolution professional video cameras, for example, that capture finer texture details than is possible with standard-definition (SD) video pictures. However, this increase in spatial resolution of pictures is not coupled with an increase in temporal resolution. As a result, redundancy reduction attempted by motion compensation does not always perform as effectively in higher resolution pictures as in lower resolution pictures due to irregular local textures and motion. Poor correlation between reference block pictures and motion compensated pictures can reduce coding efficiency.

Lossy compression results in blurring, blocking errors and other distortions, which are called artifacts in the decompressed video picture. Previously, efforts to improve video picture decoding quality have included the adoption of video post processing filters and loop filters in order to mitigate compression artifacts and reduce propagation of compression errors from motion compensation. Although these techniques are somewhat successful, they tend to reduce texture details. Therefore, there still exists a need in the art of video encoding and decoding to provide a system for decoding efficiently encoded video with minimal loss of texture details in various different formats of presenting video pictures.

### BRIEF SUMMARY OF THE INVENTION

The present invention overcomes these disadvantages by describing a universal method and apparatus that can be widely applied to codecs where inter-picture prediction or motion compensation is used, or where picture redundancy can be reduced by prediction while minimizing the loss of texture details. By not encoding redundant information we have a compression of the video data representation that can reduce the cost and storage capacity requirements as well as allow more optimal use of available bandwidth in order to provide higher resolution images with a lower data rate or storage requirement, more channel availability, and higher quality picture delivery.

Motion prediction has some limitations in resolving motion redundancy. Random noise and other random fine structures cannot be easily predicted by motion compensation. Any portion of a current block to be encoded that cannot be predicted from a previously encoded reference block may lessen the efficiency of the motion compensation. In some cases, the particular type of noise or the presence of certain fine structures yields a current block that cannot be efficiently encoded.

We have observed that a coding efficiency reversal can occur in many motion compensation cases where noise or certain fine random structures are present in the pictures. A coding efficiency reversal occurs is when the number of bits after application of certain techniques becomes larger than prior to the application of the techniques for a particular video picture. In the present case, the technique is motion compensation.

It is an object of the present invention to avoid this coding efficiency reversal by switching between two or more different modes in the architecture of the video decoder system to decode efficiently encoded video data. This novel mode allows not only for a video encoder to find the best matching reference block for motion compensation but also for the video encoder to make the best matching reference block even more effective for use with motion compensation.

The present invention provides for (a) filtering reference pictures to improve inter-picture prediction by removing random structures and noise in both encoded and decoded pictures, and (b) implementation of the reference-picture filter using a configurable loop filter. Both the encoder and decoder will have corresponding filters. Advantageously, with the new purpose of filtering reference pictures, a configurable loop filter can serve a dual-use function by either selectively filtering the decoded video based on configuration data, such as a first set of filter parameters, prior to outputting the decoded video, or selectively filtering the decoded video based on a second set of filter parameters prior to calculating the motion prediction data. The configurable loop filter can function alternately as a deblocking filter and a reference picture filter.

The selected use of the loop filter is determined by the encoder so that the raw video data is efficiently encoded with a minimum number of bits and that the encoded video data will be subsequently decoded using a corresponding predetermined filtering mode. The encoder sets a first control data associated with one or more video pictures to command the video decoder to utilize the loop filter in the predetermined manner. A video data structure carries the encoded video data as well as the management information provided for each video data block or group of blocks.

The video data structure can be arranged as a bitstream from a communication channel, or may be contained in one or more physical locations on an optical disc, Digital Versatile Disc (DVD), magnetic tape, solid-state memory, or other storage medium, for example. The communication channel can be an over-the-air (OTA) wireless network, a wireline network, or the signal from an optical reading head for an optical medium reading unit, for example. One example of a video data structure that carries management information, such as the first control data, is the Supplemental Enhancement Information (SEI) as described in the MPEG-4 AVC specification (International Standard of Joint Video Specification—Draft ISO/IEC 14496-10: 2002 E), the entire contents of which is incorporated herein by reference to disclose one arrangement of a video data structure in the environment of a bitstream from a communication channel. The above is only one example of an implementation where the video data structure 104 conveys video and management information data, and is not intended to be limiting.

Alternatively, the management information can be carried in other out-of-band carrier channels such as the MPEG-2 transport stream, the Internet Protocol (IP) Real-Time Transport Protocol (RTP), or a recording storage media file or data management layer, for example. When the management information is carried in an out-of-band channel, synchronization information must be provided in order to determine the corresponding encoded video picture associated with the control data. Similarly, configuration data must be synchronized if it arrives asynchronously to the encoded video data.

In a preferred embodiment, the present invention provides a video decoding system that includes a demultiplexer unit for receiving video data structures and outputting an encoded video data, a motion data, and an intra-prediction mode data. The demultiplexer unit can be implemented as a control unit that receives commands in the form of configuration and control data fields in the received video data structure. The control unit can parse the received video data structure to extract predetermined encoded video data, control data, and configuration data fields, for example. The decoding system includes a summing unit for receiving the encoded video data and producing a summing output data, a decoding unit for decoding the encoded data, and a loop filter for outputting filtered video data based on one or more filter modes.

The summing unit receives the encoded video data and an encoded prediction data to produce a summing output data. The decoding unit receives the summing output data and outputting a decoded video data. The loop filter unit receives the decoded video data and outputs a filtered video data based on one or more predetermined filter modes. The loop filter is configured by one or more loop filter parameters and a first control data for selecting one of the one or more predetermined filter modes.

The decoding system includes an output switch unit for receiving the decoded video data, the filtered video data, and the first control data and selectively outputting one of the decoded video data and the filtered video data as decoded output data based on the value of the first control data.

The decoding system includes a prediction unit that receives the filtered video data, the motion data, the intra-prediction mode data and a second control data and outputs an encoded prediction data. The second control data selects between the inter-prediction and intra-prediction modes. The encoded prediction data modifies the decoding of subsequently received encoded video data.

### BRIEF DESCRIPTION OF THE DRAWINGS

The exact nature of this invention, as well as the objects and advantages thereof, will become readily apparent upon consideration of the following specification in conjunction with the accompanying drawings in which like reference numerals designate like parts throughout the figures thereof and wherein:

FIG. 1 is a block diagram of a first embodiment of a decoding system.

FIG. 2 is a block diagram of a decoding unit of the embodiment.

FIG. 3 is a block diagram of a prediction unit of the embodiment.

FIG. 4 is a diagram of a sample video data structure showing the control data and configuration data being carried in the management information data.

FIG. 5 is a diagram showing sample video data structure conveying both encoded video and management information data.

FIG. 6 is a block diagram of a second embodiment of the present invention.

FIG. 7 is a block diagram showing the elements of a complete video system.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the intention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

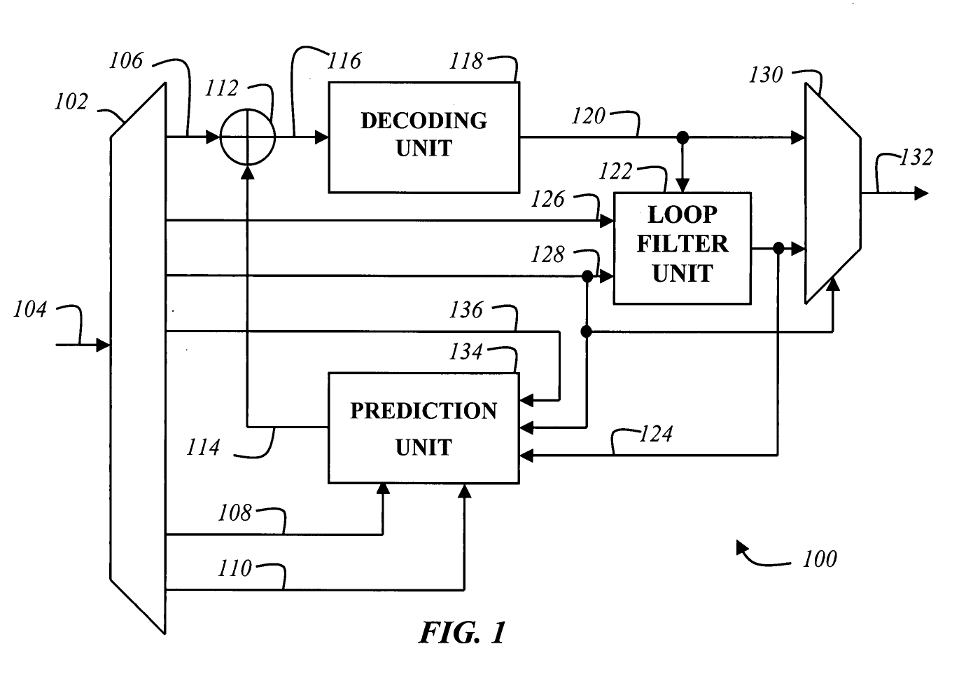

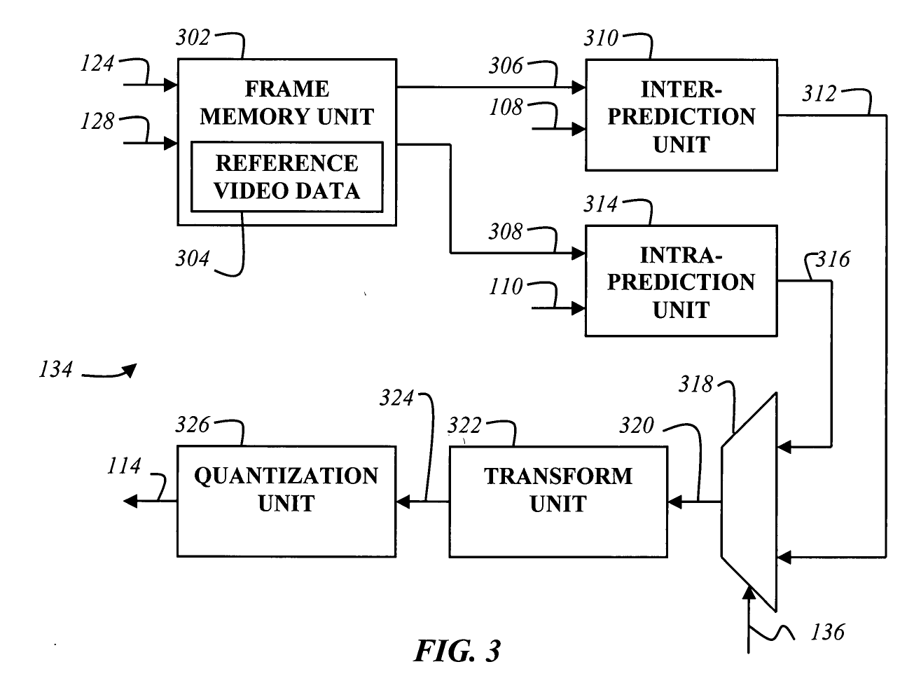

In reference to FIGS. 1-3, a first embodiment of the present invention includes a demultiplexer unit 102 for receiving video data structures 104 and outputting an encoded video data 106, a motion data 108, and an intra-prediction mode data 110. The video data structures 104 are a sequence of data information bits divided up into predetermined fields that form the representation of encoded video and audio data, as well as other associated data as described in the previously introduced MPEG-4 AVC specification. Reference can be made to U.S. Pat. No. 5,907,658 to Murase et al., the entire contents of which is incorporated herein by reference to disclose one arrangement of a video data structure in the environment of a recording medium and reproduction apparatus. This embodiment is for illustration purposes only and not as a limitation on the manner of implementing the present invention.

The demultiplexer unit 102 separates the encoded video data 106, the motion data 108, and the intra-prediction mode data 110 from the video data structures 104. The encoded video data 106 includes a plurality of transformed and quantized image samples that describe a coded video sequence. Alternatively, the demultiplexer unit 102 can be implemented as a control unit that receives, as the video data structure 104, a data stream or data file that interleaves fields containing encoded video and control data fields, for example, and routes selected fields into predetermined separate outputs. The control unit can parse the received video data structure 104 to extract predetermined encoded video data 106, control data (128, 136), and configuration data (108, 110, and 126) fields, for example.

The encoded video data 106 is passed to a summing unit 112. The summing unit receives the encoded video data 106 and an encoded prediction data 114 and produces a summing output data 116. The summing output data 116 is an arithmetic sum of the encoded video data 106 and the encoded prediction data 114. The encoded prediction data 114 provides an “error data” that is added to the received encoded video data 106 in order to determine a predicted improvement to the received encoded video data 106 prior to decoding. Alternatively, the summing output data 116 can be the result an arithmetic function that is complementary with the type of prediction information, and is not limited to only an arithmetic sum. For example, the arithmetic function can be subtraction, scaling, or normalization to or within a predetermined range of values.

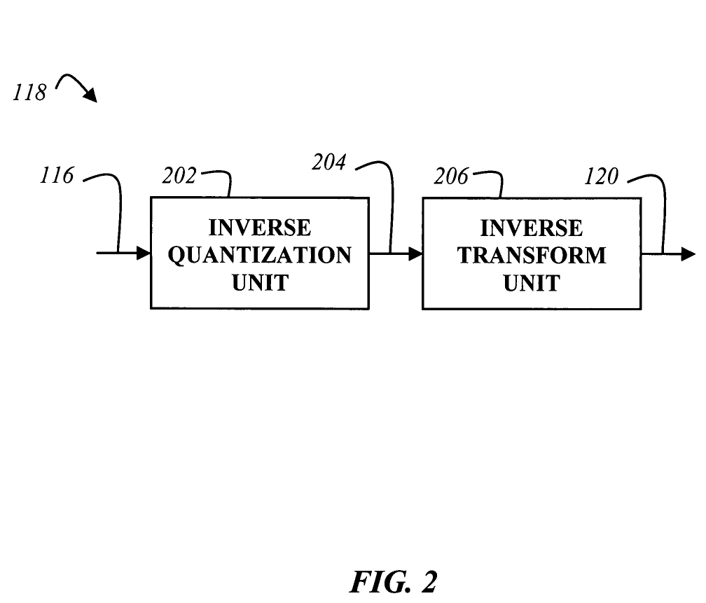

The summing output data 116 is then passed to a decoding unit 118 that outputs a decoded video data 120. In reference to FIG. 2, the decoding unit 118 includes an inverse quantization unit 202 and an inverse transform unit 206. The inverse quantization unit 202 receives the summing output data 116 and outputs a transformed video data 204. The decoding system receives encoded data that has been transformed and quantized. The decoder unit 118 reverses both processes by inverse quantizing and then inverse transforming to recover a decompressed (uncompressed) representation of the original picture data.

The summing output data 116 is represented in a binary word of a first predetermined bit length and the transformed video data 204 is represented in a binary word of a second predetermined bit length. The inverse quantization unit 202 restores a quantized data to a former representation length. Quantization introduces a loss of information. Specifically, a predetermined number of Least-Significant Bits (LSBs) are truncated leaving a predetermined number of Most-Significant Bits (MSBs). The selection of the number of MSBs remaining after quantization has an effect on the storage and processing requirements. More MSBs will give a finer representation at the expense of a larger bit-width while fewer MSBs will give a coarser representation and a smaller bit-width. The inverse quantization process restores the encoded video data to its former length, but it cannot restore the lost information that the previously truncated bits conveyed.

The inverse transform unit 206 receives the transformed video data 204 and outputs a decoded video data 120. The inverse transform unit 206 provides a transformation of the transformed video data 204 from the frequency domain to the spatial domain. Preferably, this transformation can be an Inverse Discrete Cosine Transform (IDCT) or IDCT-like transform. An IDCT-like transform is any mathematic transform that, after applying to the picture data, yields approximately the same numerical values as the IDCT transform and can be used in a picture encoder or decoder as in the inverse transform unit 206 after the inverse-quantization where a IDCT transform can be used instead. This includes the matrix-based inverse transform as disclosed in the previously introduced MPEG-4 AVC specification. The decoded video data 120 is passed both to a loop filter unit 122 and an output switch unit 130.

The loop filter unit 122 receives the decoded video data 120 and outputs a filtered video data 124 based on one or more predetermined filter modes. The loop filter unit 122 is configured by one or more loop filter parameters in the configuration data 126. The loop filter parameters in the configuration data 126 can be carried in the present video data structure 104 as configuration data, can be stored from a previous video data structure, or can be computed from a combination of management information derived in part from a present or previous video data structure 104 and the current state of the loop filter unit 122. The loop filter unit 122 receives control data, for example in the form of a first control data 128, for selecting one of the one or more predetermined filter modes.

The loop filter unit 122, which can operate alternately as a deblocking loop filter and a reference picture filter, operates on macroblocks composed of blocks of image data arranged in a 4×4, 8×8, or 16×16 block patterns, for example. The loop filter unit 122 when utilized as a deblocking filter is intended to remove artifacts that may result from adjacent blocks within and around the border of a given macroblock having been heavily quantized, having different estimation types such as inter-prediction versus intra-prediction, or having different quantization scales.

A deblocking filter modifies the pixels on either side of a block boundary using a content adaptive non-linear filter that utilizes configuration data 126 including a first set of filter parameters as coefficients for the loop filter unit 122, to provide a predetermined first level of filtering. Higher coefficient values tend to produce a stronger filtering which can effectively remove most noise, but can also remove some fine picture texture. Conversely, lower coefficient values tend to produce a weaker filtering. The loop filter unit 122, when utilized as a reference picture filter, is intended to smooth the reference picture prior to use in prediction and utilizes configuration data 126 including a second set of filter parameters, to provide a predetermined level of filtering. When the loop filter unit 122 is operating as a reference picture filter, the filtered decoded video data is used as reference data only and not output to a display unit.

In one example, each set of filter parameters can include a FilterOffsetrA and a FilterOffsetrB comprising filter offset parameters for each set which operate to determine a filter mode with a predetermined filter strength. The settings of FilterOffsetrA and FilterOffsetrB are usually lower for a weaker filtering, when the loop filter unit 122 is used as a deblocking filter, while the settings are usually higher for a stronger filtering when the loop filter is used as a reference picture filter. The filter parameters can be selected from a table of parameter values calculated to provide a predetermined filtering strength as described in the MPEG-4 AVC specification (ISO standard—Draft ISO/IEC 14496-10: 2002 E). Alternatively, the control data and configuration data can alter or modify the filtering function as well as the filtering parameters to create a predetermined filter response. This modification will persist for at least the reproduction period of the video data while the video data is being processed.

Some qualitative factors for selecting the appropriate filter coefficients and architecture include (a) the loop filter unit 122 implements a low-pass filter that is adaptive and tunable which means the filter parameters can be modified by prior filter results as well as the management information, (b) the low-pass filter can be either linear or non-linear, (c) the filtering strength can be considered to be high if the low-pass filter has a narrower pass-band or a wider spatial spread, (d) the filtering strength is adaptable so that if the signal to noise ratio (SNR) is high, the filter strength can be decreased, and if the SNR is low, the filter strength can be increased, (e) the filtering strength is set relatively high for low SNR when the picture content is soft or includes a relatively high degree of motion, (f) the filtering strength is set relatively high for a low SNR when the pictures include simple motion such as translation or constant camera panning, and (g) utilizing an appropriate noise model and remove as much noise as possible.

The output switch unit 130 receives the decoded video data 120, the filtered video data 124, and the first control data 128. The output switch unit 130 selectively outputs one of the decoded video data 120 and the filtered video data 124 as decoded output data 132 based on the value of the first control data 128. The first control data 128 value is set to efficiently decode the encoded video data 106. When the first control data 128 selects the output of the decoder unit 118 as the decoded output data 132, the loop filter unit 122 is configured by a first set of parameters in order to produce a more optimal reference picture for use in prediction. When the first control data 128 selects the output of the loop filter unit 122 as the decoded output data 132, the loop filter unit 122 is configured by a second set of parameters. The output of the filter unit 122 is passed to a prediction unit 134.

The prediction unit 134 receives the filtered video data 124, the motion data 108, the intra-prediction mode data 110 and control data, for example in the form of a second control data 136, and outputs prediction data 114. The second control data 136 selects between the inter-prediction data 312 and the intra-prediction data 316. The prediction data 114 modifies the decoding of subsequently received encoded video data. The prediction unit 134 includes a frame memory unit 302 for holding a reference video data 304, an inter-prediction unit 310, and intra-prediction unit 314, a second switch unit 318, a transform unit 322 and a quantization unit 326. The prediction unit 134 provides a prediction data 114 for more accurately decoding subsequently received encoded video data 106.

The frame memory unit 302 receives the filtered video data 124 and selectively stores a reference video data 304. The reference video data 304 is used to represent a starting point from which to predict other encoded video data 106. The reference video data 304 can be captured, under the control of the first control data 128, at regular intervals, or irregularly depending on the decoded video data 120 and the management information control data 126 and configuration data 128. The frame memory unit 302 outputs an inter-prediction reference video data 306 and an intra-prediction reference video data 308.

The inter-prediction unit 310 receives the inter-prediction reference video data 306 and the motion data 108 and outputs an inter-prediction data 312. The inter-prediction unit 310 provides prediction information for predicting encoded video data 106 changes between one or more encoded video data samples.

The intra-prediction unit 314 receives the intra-prediction reference video data 308 and the intra-prediction mode data 110 and outputs an intra-prediction data 316. The intra-prediction unit 314 provides prediction information for predicting encoded video data 106 changes within an encoded video data sample.

The second switch unit 318 receives the inter-prediction data 312 and the intra-prediction data 316 and outputs a prediction data 320. The second switch unit 318 receives a second control data 136 for selecting between outputting the inter-prediction data 312 and the intra-prediction data 316.

The transform unit 322 receives the prediction data 320 and outputs a transformed prediction data 324. The transform unit 322 provides a transformation of the prediction data 320 from the spatial domain to the frequency domain. The transformation provided by the transform unit 322 is preferably a Discrete Cosine Transform (DCT) or DCT-like transform. A DCT-like transform is any mathematic transform that, after applying to the picture data, yields approximately the same numerical values as a DCT and can be used in a picture encoder or decoder as the transform unit 322 before the quantization where a DCT transform can be used instead. This includes the matrix based transform as disclosed in the previously introduced MPEG-4 AVC specification.

The quantization unit 326 receives the transformed prediction data 324 and outputs the encoded prediction data 114. The transformed prediction data 324 is represented in a binary word having a second predetermined bit length corresponding to the transformed video data 204. The encoded prediction data 114 is represented in a binary word having a first predetermined bit length corresponding to the summing output data 116. The transform unit 322 and the quantization unit 326 generate an encoded prediction data 114 that is arithmetically compatible with the summing output data 116 in order to facilitate their combination in an arithmetic function. In summary, the present invention improves the effectiveness of motion compensation by selectively avoiding coding efficiency reversal when noise and other random structures are present. In this case, only the stored reference video data 304 are filtered using a second set of filter parameters in the configuration data 126.

The demultiplexer unit 102, the summing unit 112, the decoding unit 118, the loop filter unit 122, the output switch unit 130, the prediction unit 134, and any sub-units thereof, may be implemented using a programmed microprocessor wherein the microprocessor steps are implemented by a program sequence stored in a machine-readable medium such as a solid-state memory, or disc drive, for example.

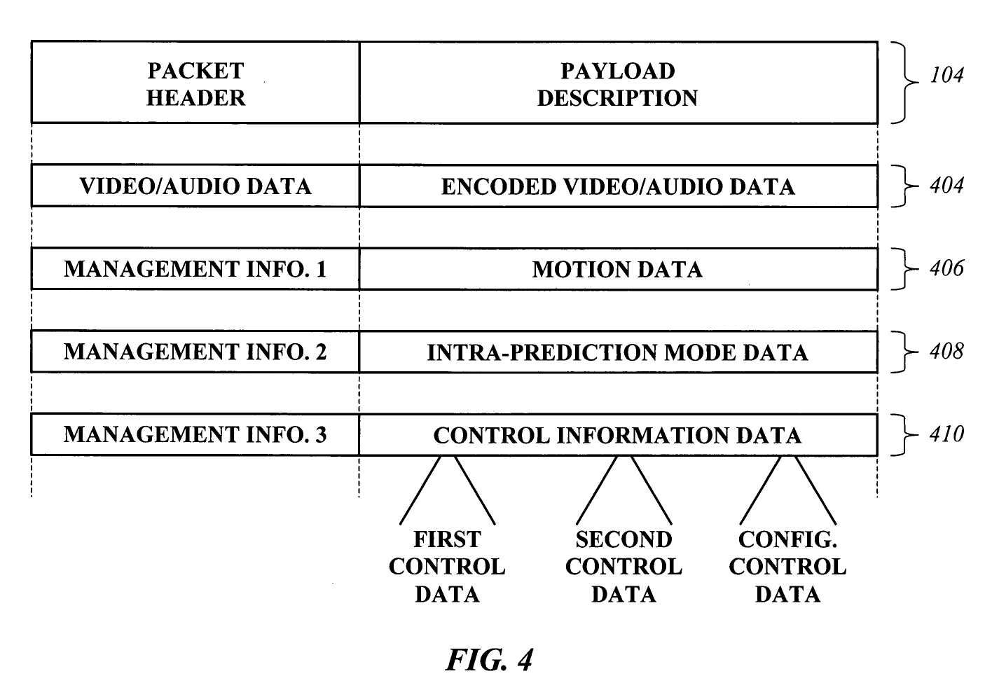

FIG. 4 is a diagram of a video data structure 104 that includes encoded video and audio data, as well as other associated data. One or more video data structures 104 can be carried in a bitstream as a sequence of bits over a network, or stored on a recording medium for reading and decoding by a video decoding apparatus. Video data structures 104 can take various forms including but not limited to video data structures conveying encoded video/audio data 404, conveying motion data 406, conveying intra-prediction mode data 408, and conveying control information data 410.

Video data structures may be concatenated together with a combined header, or may be sent or stored separately with an identifying header for each type of video data structure 104. Similarly, a video data structure can convey more than one type of data content such as conveying encoded video/audio data as well as control information or other management information data. If the component data required for decoding a particular encoded video data is received out of order, the control unit can reassemble the component data prior to decoding.

The first control data 128 and the second control data 136 can be assigned as one or more bits in a particular field of the management information being sent from an encoder to a decoder or stored on a recorded media. These bits may also be considered as flags and used to initiate or enable the predetermined function. For example, the first control data can be implemented as a flag deblocking_filter_for_motion_pred and added to the video data structure. In this specific case, the different values for FilterOffsetrA and FilterOffsetrB are selected when deblocking_filter_for_motion_pred changes value. This flag and other flags can be implemented as more than one binary digit (bit), and can select between more than two values. An encoder and decoder using these features require the same filter to ensure compatibility.

The various components of the video data structures 104 including the encoded video data 106, the motion data 108, and the intra-prediction mode data 110 can be sent separately and reassembled prior to applying this data to the decoding system 100. The location and meaning of various bits in the video data structures 104 can be defined by a standard such as the H.264/AVC Video Coding Standard, for example. In this case, the management information can be carried by Supplemental Enhancement Information (SEI) regions of an MPEG-4/AVC bitstream, for example.

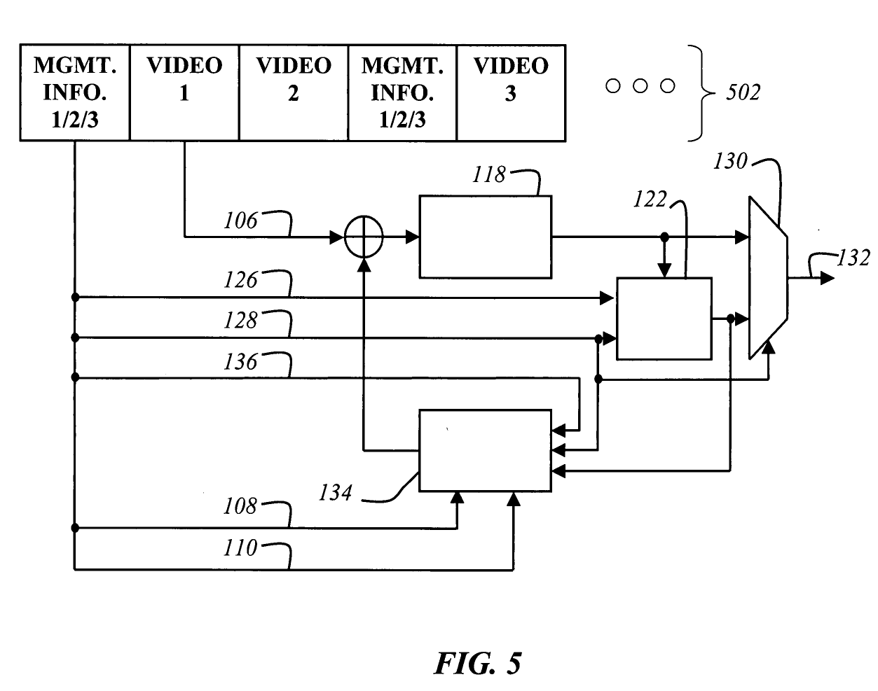

In reference to FIG. 5, a collection of video data structures 104 is shown where encoded video data 106 is extracted from a video data structure 104 of the type conveying encoded video/audio data 404. One embodiment of a video data structure format includes video encoded video data 104 without an audio component. Hence, the encoded video/audio data only conveys only encoded video data 106. Alternatively, another embodiment of a video data structure format may include only audio data, and a third embodiment may include the video and audio data concatenated together or interleaved within the same video data structure 104. FIG. 5 also shows where management information is extracted from one or more management information video data structures (406, 408, 410), for example.

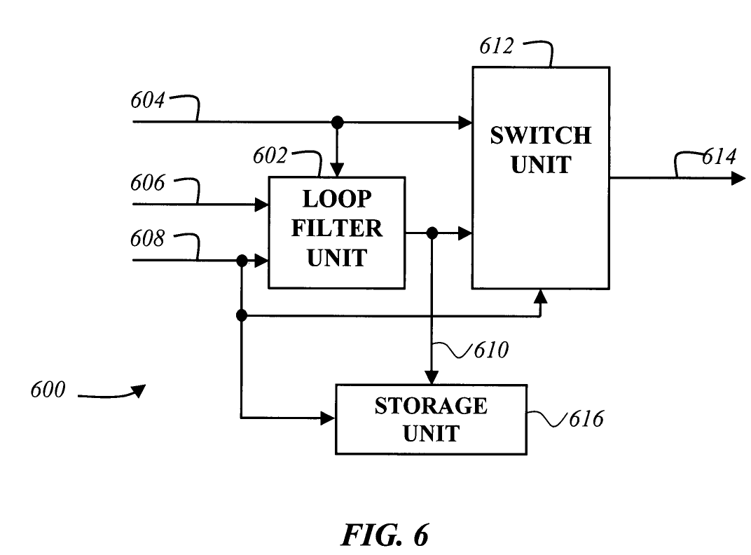

In reference to FIG. 6, a second embodiment of the present invention includes a configurable loop filter unit 602, a switch unit 612, and a storage unit 616. The configurable loop filter unit 602 receives decoded video data 604, configuration data 606, and control data 608 and outputs a filtered decoded video data 610 based on one of a plurality of predetermined filter modes. Each of the plurality of predetermined filter modes is determined by the configuration data 606 and control data 608.

The switch unit 612 receives the decoded video data 604 and the filtered decoded video data 610 and selectively outputs one of the decoded video data 604 and the filtered decoded video data 610 as decoded output data 614 based on the control data 608. The storage unit 616 can selectively store a decoded video data as a reference video data.

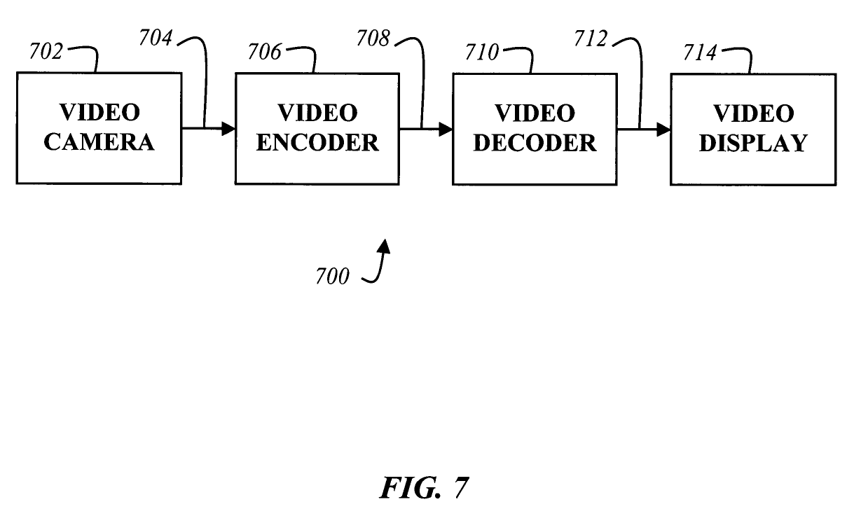

In reference to FIG. 7, elements of a complete video system 700 are shown. The video system 700 includes a video camera 702 that sends uncompressed video data 704 to a video encoder 706. The video encoder 706 receives the uncompressed video data 704 and produces an encoded video data 708. The encoded video data 708 can be conveyed using video data structures 104 to a video decoder 710.

The video data structures 104 may be passed to the video decoder 710 as a bitstream of data passed along a communication channel such as a wireline communication network, a wireless network, or by distributing a media element such as a DVD, an optical disc, a compact disc (CD), a magnetic tape, a computer diskette, a solid-state memory, or other portable recording storage medium. The video decoder 710 receives the encoded video data 708 and produces decoded video data 712 which is passed to a video display unit 714 for display to a user.

Those skilled in the art will appreciate that various adaptations and modifications of the just-described preferred embodiments can be configured without departing from the scope and spirit of the invention. Therefore, it is to be understood that, within the scope of the amended claims, the invention may be practiced other than as specifically described herein.

What is claimed is:

1. A configurable loop filter system for a video decoding system, comprising:
a control unit for receiving management information and outputting configuration data and control data, the configuration data and control data being conveyed by the received management information;
a configurable loop filter unit for receiving decoded video data and outputting filtered decoded video data based on one of a plurality of predetermined filter modes, each of the plurality of predetermined filter modes being determined by the configuration data and control data;
a switch unit for receiving the decoded video data and the filtered decoded video data and selectively outputting one of the decoded video data and the filtered decoded video data as decoded output data based on the control data; and
a storage unit for selectively storing the filtered decoded video data, the stored filtered decoded video data being used as a reference video data.

2. The configurable loop filter system of claim 1,
wherein the configuration data includes at least one filter parameter for each filter mode.

3. The configurable loop filter system of claim 1,
wherein the storage unit selectively stores a predetermined decoded video data based on the control data.

4. The configurable loop filter system of claim 1,
wherein at least one of the predetermined filter modes is adaptive.

5. A video decoding system, comprising:
a demultiplexer unit for receiving a video data structure and outputting an encoded video data, a motion data, and an intra-prediction mode data, the demultiplexer unit extracting the encoded video data, the motion data, and the intra-prediction mode data from the video data structure, the encoded video data including a plurality of transformed and quantized image samples;
a summing unit for receiving the encoded video data and an encoded prediction data to produce a summing output data, the summing output data being an arithmetic sum of the encoded video data and the encoded prediction data;
a decoding unit for receiving the summing output data and outputting a decoded video data;
a loop filter unit for receiving the decoded video data and outputting a filtered video data based on one or more predetermined filter modes, the loop filter unit being configured by one or more loop filter parameters, the loop filter unit receiving a first control data for selecting one of the one or more predetermined filter modes;
an output switch unit for receiving the decoded video data, the filtered video data, and the first control data, the output switch unit selectively outputting one of the decoded video data and the filtered video data as decoded output data based on the value of the first control data, the first control data value being set to efficiently decode the encoded video data; and
a prediction unit for receiving the filtered video data, the motion data, the intra-prediction mode data and a second control data and outputting an encoded prediction data, the encoded prediction data for modifying the decoding of subsequently received encoded video data.

6. The video decoding system of claim 5, wherein the decoding unit further comprises:
an inverse quantization unit for receiving the summing output data and outputting a transformed video data, the summing output data having a first predetermined bit length and the transformed video data having a second predetermined bit length; and
an inverse transform unit for receiving the transformed video data and outputting a decoded video data, the inverse transform unit providing a transformation of the transformed video data from the frequency domain to the spatial domain.

7. The video decoding system of claim 6,
wherein the transformation provided by the inverse transform unit is an inverse discrete cosine transform like (IDCT-like) mathematical transform.

8. The video decoding system of claim 5, wherein the loop filter unit further comprises:
a first filter offset value and a second filter offset value operable to determine a first filter mode with a predetermined first filter strength;
a third filter offset value and a fourth filter offset value operable to determine a second filter mode with a predetermined second filter strength,
wherein the first control data selects one of the first filter mode and the second filter mode.

9. The video decoding system of claim 5,
wherein one or more video data structures are stored on a recording storage medium.

10. The video decoding system of claim 5,
wherein one or more video data structures are carried within a bitstream.

11. The video decoding system of claim 5, wherein the prediction unit further comprises:
a frame memory unit for receiving the filtered video data and selectively storing a reference video data, the frame memory unit outputting an inter-prediction reference video data and an intra-prediction reference video data;
an inter-prediction unit for receiving the inter-prediction reference video data and the motion data and outputting an inter-prediction data, the inter-prediction unit for providing prediction information for predicting encoded video data changes between one or more encoded video data samples;
an intra-prediction unit for receiving the intra-prediction reference video data and the intra-prediction mode data and outputting an intra-prediction data, the intra-prediction unit for providing prediction information for encoded video data changes within an encoded video data sample;
a second switch unit for receiving the inter-prediction data and the intra-prediction data and outputting a prediction data, the second switch unit receiving a second control data for selecting between outputting the inter-prediction data and the intra-prediction data;
a transform unit for receiving the prediction data and outputting a transformed prediction data, the transform unit providing a transformation of the prediction data from the spatial domain to the frequency domain; and
a quantization unit for receiving the transformed prediction data and outputting the encoded prediction data, the transformed prediction data being represented in a binary word having the second bit length, the encoded prediction data being represented in a binary word having the first bit length.

12. The video decoding system of claim 11,
wherein the transformation provided by the transform unit is a discrete cosine transform like (DCT-like) mathematical transform.

13. A recording medium comprising:
a data information region for storing a plurality of video data structures representing at least video data; and
a management information region for storing loop filter information associated with the respective plurality of video data,
wherein the management information controls setting loop filtering applied to the corresponding video data.

14. The recording medium of claim 13,
wherein the management information indicates one of a first filter mode and a second filter mode.

15. The recording medium of claim 13,
wherein the management information is effective for setting loop filtering architecture and parameters applied to the corresponding video data for at least the reproduction period of the video data.

16. A method of efficiently decoding selectively filtering encoded video data, comprising:
receiving an encoded video data, a first control data, and a configuration data;
decoding the encoded video data to produce a decoded video data;
filtering the decoded video data based on the first control data and the configuration data to produce a filtered decoded video data;
outputting one of the decoded video data and the filtered decoded video data based on the first control data.

17. A configurable video decoding architecture, comprising:
a control unit for receiving a management information and outputting configuration data and control data; and
a dual-use loop filter unit for receiving a decoded video data, the configuration data, and the control data, the configuration data including two or more filter offset parameter data sets, the offset parameter data sets being composed of at least two offset parameters each, the filter offset parameters being selected from a table of values based on the operation of the loop filter unit as one of a deblocking filter and a reference picture filter.

18. A video decoding system, comprising:
a control unit for receiving management information and outputting configuration data and control data, the configuration data and control data being conveyed by the received management information;
a configurable loop filter unit for receiving decoded video data and outputting filtered decoded video data based on one of a plurality of predetermined filter modes, each of the plurality of predetermined filter modes being determined by the configuration data and control data;
a switch unit for receiving the decoded video data and the filtered decoded video data and selectively outputting one of the decoded video data and the filtered decoded video data as decoded output data based on the control data; and
a prediction unit for selectively storing filtered decoded video data as a reference video data, the reference video data being used to produce an encoded prediction data that is arithmetically combined with one or more encoded video data.

19. The video decoding system of claim 18, the prediction unit further comprising:
an inter-prediction unit for receiving the reference video data and the motion data and outputting an inter-prediction data, the inter-prediction unit for providing prediction information for predicting encoded video data changes between one or more encoded video data samples;
an intra-prediction unit for receiving the reference video data and the intra-prediction mode data and outputting an intra-prediction data, the intra-prediction unit for providing prediction information for encoded video data changes within an encoded video data sample; and
a second switch unit for receiving the inter-prediction data and the intra-prediction data and outputting a prediction data, the second switch unit receiving a second control data for selecting between outputting the inter-prediction data and the intra-prediction data.

20. A machine-readable medium having one or more instructions for decoding video from a communication channel, which when executed by a processor, causes the processor to perform operations comprising:
receiving an encoded video data, a first control data, and a configuration data;
decoding the encoded video data to produce a decoded video data;
filtering the decoded video data based on the first control data and the configuration data to produce a filtered decoded video data; and
outputting one of the decoded video data and the filtered decoded video data based on the first control data.

21. The machine-readable medium of claim 20, which when executed by a processor, causes the processor to perform operations further comprising:
storing a predetermined decoded video data as reference video data, the reference video data being used in the reproduction of one or more video pictures.
